(19) United States
(12) Patent Application Publication
(10) Pub. No.: US 2010/0274828 A1
(43) Pub. Date: Oct. 28, 2010

(54) Electronic Device, Storage Area Allocation Method for File System, and Computer Product

(76) Inventor: Takuya Ootani, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/620,318

(22) Filed: Nov. 17, 2009

(30) Foreign Application Priority Data
Apr. 24, 2009 (JP) 2009-106846

(51) Int. Cl. G06F 12/02; G06F 12/00

(52) U.S. Cl. 707/813; 707/E17.01; 711/E12.001; 711/E12.002

(57) ABSTRACT

According to one embodiment, an electronic device includes a dividing module and an allocation module. The dividing module divides a data storage area, to which file data constituting a file is to be written, into a plurality of management areas. The data storage area is in the storage area of a storage medium. The allocation module allocates, upon receipt of a write request to write file data, an area to the file data corresponding to the write request as a write area. The write area is subsequent to an area where file data is written in a management area where file data constituting the same file as the file data corresponding to the write request is written.

### CROSS-REFERENCE TO RELATED APPLICATIONS

This application is based upon and claims the benefit of priority from Japanese Patent Application No. 2009-106846, filed on Apr. 24, 2009, the entire contents of which are incorporated herein by reference.

### BACKGROUND

1. Field

One embodiment of the invention relates to an electronic device, a storage area allocation method for a file system, and a computer product.

2. Description of the Related Art

A file system controls data write to a storage device such as a memory card and a hard disk drive (HDD). When writing file data that constitute a file to a storage device in response to a data write request from an application or the like, the file system sequentially writes the file data to the storage device from the top of the storage areas therein (see Japanese Patent Application Publication (KOKAI) No. 2006-285669).

In general, when file data that constitute a file are written to a storage device, it is preferable that pieces of the file data be sequentially and continuously written to the storage device. This is because, especially to a semiconductor memory such as a memory card, if data are written in relatively large units, processing speed increases upon writing data to or reading data from the storage device. For example, in the case of a memory card, if data is written in units of 128 KB to the storage device, processing speed increases to write data to and read data from the storage device.

In the case where file data that constitute a plurality of files are simultaneously written to a storage device in response to a data write request from an application or the like, file data that constitute each of the files are randomly written to the storage device. This results in the loss of the continuity of file data that constitute the same file on the storage device.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic block diagram of a personal computer (PC) and a memory card managed by the PC according to an embodiment of the invention;

FIG. 2 is an exemplary schematic diagram of a memory space logically formatted by a file allocation table (FAT) file system in the embodiment;

FIG. 3 is an exemplary schematic diagram of FAT and a file entry in the embodiment;

FIG. 4 is an exemplary schematic diagram of a memory space logically formatted by a file system in the embodiment;

FIG. 5 is an exemplary flowchart of a storage area allocation process performed by the file system in the embodiment;

FIG. 6 is an exemplary schematic diagram of a file data block divided into a plurality of management areas in the embodiment;

FIG. 7 is an exemplary schematic diagram for explaining the allocation of write areas in the embodiment;

FIG. 8 is an exemplary schematic diagram for explaining the allocation of write areas according to a conventional technology; and

FIG. 9 is an exemplary block diagram of the PC in the embodiment.

### DETAILED DESCRIPTION

Various embodiments according to the invention will be described hereinafter with reference to the accompanying drawings. In general, according to one embodiment of the invention, an electronic device comprises a dividing module and an allocation module. The dividing module is configured to divide a data storage area, to which file data constituting a file is to be written, into a plurality of management areas. The data storage area is in the storage area of a storage medium. The allocation module is configured to allocate, upon receipt of a write request to write file data, an area to the file data corresponding to the write request as a write area. The write area is subsequent to an area where file data is written in a management area where file data constituting the same file as the file data corresponding to the write request is written.

According to another embodiment of the invention, there is provided storage area allocation method for a file system comprising: a dividing module dividing a data storage area, to which file data constituting a file is to be written, into a plurality of management areas, the data storage area being in a storage area of a storage medium; and an allocation module allocating, upon receipt of a write request to write file data, an area to the file data corresponding to the write request as a write area. The write area is subsequent to an area where file data is written in a management area where file data constituting the same file as the file data corresponding to the write request is written.

According to still another embodiment of the invention, a computer program product embodied on a computer-readable medium and comprising code that, when executed, causing a computer to implement the above method.

In the following, an embodiment of the invention will be described. While an electronic device of the embodiment will be described as a personal computer (PC), the electronic device may be any device provided with a file system that manages data stored in a managed storage medium, such as a digital television and a recorder.

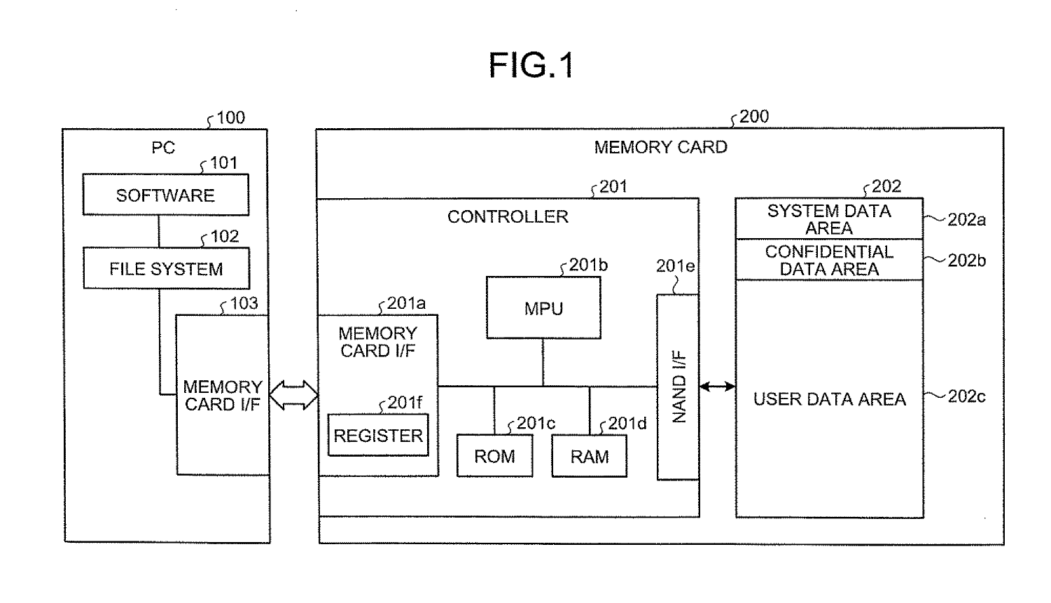

FIG. 1 is a functional block diagram schematically illustrating a personal computer (PC) 100 and a memory card 200 managed by the PC 100 according to the embodiment. Each of the functional blocks may be implemented by hardware, computer software, or a combination thereof. To clarify this point, each functional block will be described from the viewpoint of its function. Whether such a function is implemented by hardware or software depends on a specific mode of operation or a design limitation on the entire system.

As illustrated in FIG. 1, the PC 100 comprises hardware and software (system) to access the memory card 200 connected thereto. More specifically, the PC 100 comprises software 101. Examples of the software 101 include an application and an operating system (OS). The software 101 is executed by a central processing unit (CPU) upon receipt of an instruction from the user through an input device (not illustrated) to write data to or to read data from the memory card 200. Having executed the software 101, the CPU instructs to write data to or to read data from the memory card 200 through a file system 102.

The file system 102 is a mechanism to manage a file stored in a managed storage medium (the memory card 200). The file system 102 stores management information in a storage area of the storage medium, and manages the file based on the management information. In the file system 102, it is defined how to create directory information such as a file and a folder in a storage medium, how to move and delete a file, a folder, and the like, how to store data, the location of an area where the management information is stored, and how to use the management information. The file system 102 is on the basis of an FAT file system, and is capable of operation described herein. A specific operation will be described accordingly.

The PC 100 comprises a memory card interface (I/F) 103. The memory card I/F 103 comprises hardware and software necessary to interface between the PC 100 and the memory card 200. That is, the PC 100 communicates with the memory card 200 through the memory card I/F 103. The memory card I/F 103 defines various regulations necessary for communication between the PC 100 and the memory card 200. Further, the memory card I/F 103 is provided with pairs of various commands mutually recognizable by the memory card I/F 103 and a memory card I/F 201a of the memory card 200, which will be described later. The memory card I/F 103 has a hardware configuration (the location and number of pins, etc.) connectable to the memory card I/F 201a of the memory card 200.

When the memory card 200 is connected to the PC 100, or when the PC 100 is turned on while the memory card 200 inserted in the PC 100 in OFF mode is present therein, the memory card 200 is supplied with power. Thus, after performing the initialization, the memory card 200 performs processing according to access from the PC 100. The memory card 200 comprises a memory 202 and a controller 201 that controls the memory 202. The memory 202 may be, for example, a NAND flash memory.

The memory 202 nonvolatilely stores data, and writes and reads data in units referred to as pages each including a plurality of memory cells. A physical address is assigned to each of the pages. Besides, the memory 202 deletes data in units referred to as physical blocks each including a plurality of pages. The physical address may be assigned to each of the physical blocks.

The controller 201 manages the storage state of data in the memory 202. The term “storage state” as used herein refers to a relationship between the physical address of a page (a physical block) and the logical address of data stored therein assigned by the PC 100, the physical address of a page (a physical block) in delete state (page written with nothing or storing invalid data).

The controller 201 comprises the memory card I/F 201a, a micro processing unit (MPU) 201b, a read only memory (ROM) 201c, a random access memory (PAM) 201d, and a NAND I/F 201e.

The memory card I/F 201a comprises hardware and software necessary to interface between the PC 100 and the controller 201. That is, the memory card 200 (the controller 201) communicates with the PC 100 through the memory card I/F 201a. As with the memory card I/F 103, the memory card I/F 201a defines regulations enabling communication between the PC 100 and the memory card 200. Further, the memory card I/F 103 is provided with pairs of various commands. The memory card I/F 201a also has a hardware configuration (the location and number of pins, etc.).

The memory card I/F 201a comprises a register 201f.

The MPU 201b controls the overall operation of the memory card 200. For example, when the memory card 200 is supplied with power, the MPU 201b reads firmware (control program) from the ROM 201c into the RAM 201d and performs predetermined processing. According to the control program, the MPU 201b creates various tables (described later) on the RAM 201d. The MPU 201b also performs predetermined processing with respect to the memory 202 in response to a write command, a read command, or a delete command from the PC 100.

The ROM 201c stores the control program executed by the MPU 201b and the like. The RAM 201d provides a work area to the MPU 201b, and stores the control program and various types of tables. Among such tables is a conversion table (logical-to-physical table) for converting a logical address assigned to data by the file system 102 to the physical address of a page that actually stores the data. The NAND I/F 201e interfaces between the controller 201 and the memory 202.

The storage area of the memory 202 is divided into a plurality of areas according to the types of data to be stored therein. The areas include a system data area 202a, a confidential data area 202b, and a user data area 202c.

The system data area 202a is an area to store data necessary for the operation of the controller 201 in the memory 202. The system data area 202a mainly stores management information related to the memory card 200 including security information of the memory card 200 and card information such as a medium ID. The confidential data area 202b stores key information used for encryption and confidential data used for authentication. The PC 100 is not allowed to access the confidential data area 202b.

The user data area 202c can be freely accessed from the PC 100, and stores user data such as, for example, an AV content file and image data. Hereinafter, the memory 202 indicates the user data area 202c. The controller 201 secures part of the user data area 202c to store the control data (logical-to-physical table) necessary for the operation thereof. The user data area 202c is logically formatted from the PC 100 as another volume for file management.

In the following, the logical format of the memory 202 will be described. The memory 202 is logically formatted in a manner described below. The logical format is performed by the file system according to the embodiment (for example, the file system 102 in the PC 100).

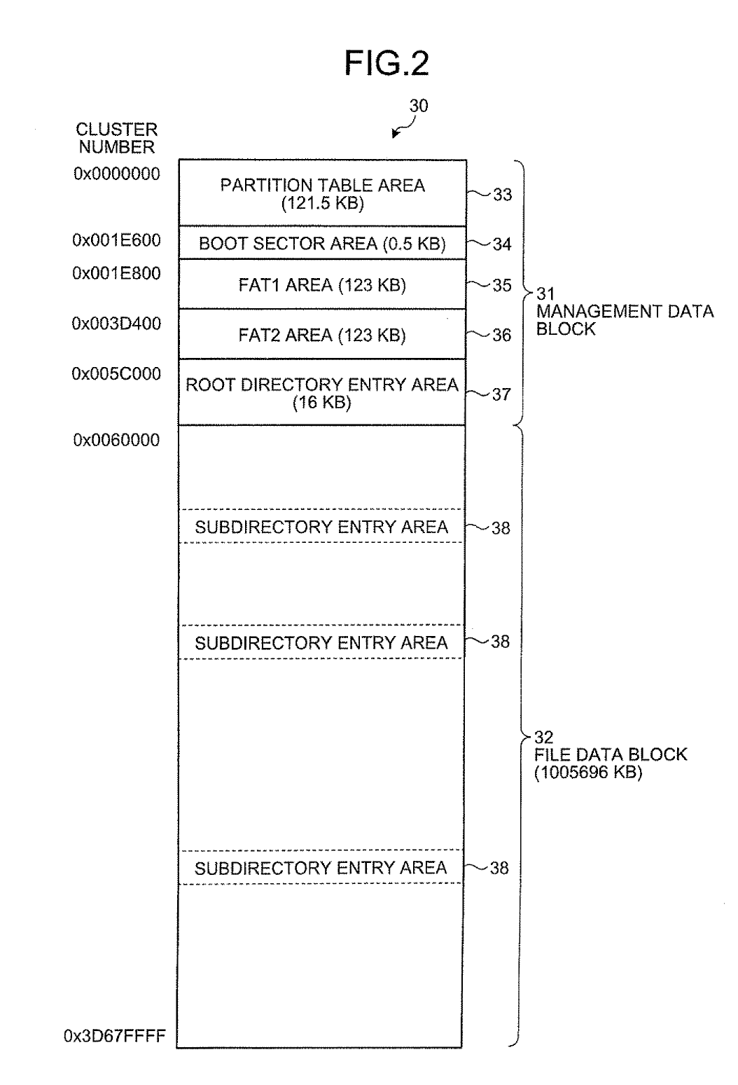

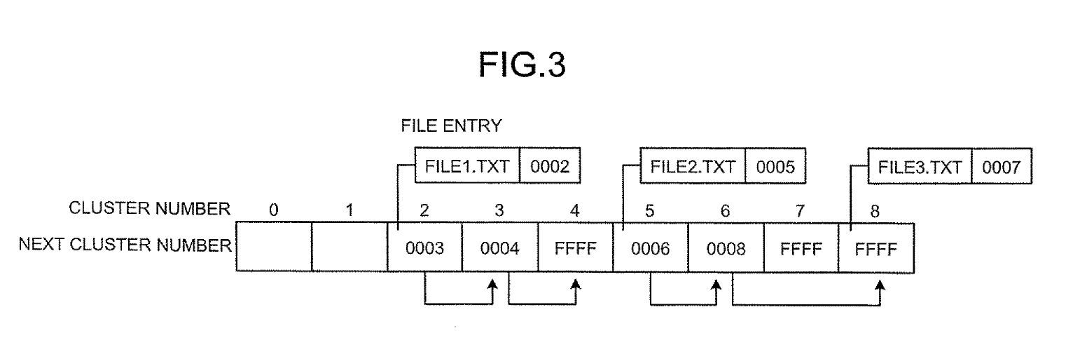

Preceding the description of the logical format of the memory 202 by the file system 102, the outline of the FAT file system, the basis of the file system 102, will be described with reference to FIGS. 2 and 3. FIG. 2 illustrates a memory space logically formatted by the FAT file system. Some pieces of management data are written to the memory space. It is assumed herein that the memory space is a memory area that the FAT file system can freely access, and corresponds to the user data area 202c of the memory 202 illustrated in FIG. 1.

As illustrated in FIG. 2, the FAT file system divides a memory space 30 of a memory to be managed into a clusters of a predetermined size (for example, 16 K bytes). Management data is assigned to an area of the memory space 30 from the bottom to a cluster with a cluster number within a predetermined range. Hereinafter, the area that stores the management data is referred to as a management data block 31. A storage area of the memory 202 (the memory card 200) with a cluster number higher than that of the management data block 31 is a data storage area (hereinafter, referred to as a file data block 32) to which file data constituting a file is written.

The management data block 31 is further divided into a partition table area 33 allocated to a partition table, a boot sector area 34 allocated to a boot sector, a FAT1 area 35 and a FAT2 area 36 allocated to FAT1 and FAT2, respectively, and a root directory entry area 37 allocated to a root directory entry. The partition table area 33 stores information such as the file system type of each partition and the head sector. The boot sector area 39 is located at the head sector indicated by the partition table, and stores a basic input/output system (BIOS) parameter block (BPB). The BPB indicates various parameters of the memory 202 used by the file system. When logically formatting the memory 202, the FAT file system writes the parameters. By reading the BPB upon activation, the FAT file system recognizes the parameters for the file format.

The FAT1 area 35 stores information such as a cluster that stores each part of file data (hereinafter, simply referred to as “file data”) written to the memory and divided into parts in cluster size and a relationship between clusters to restore the file data. The FAT2 area 36 is a back-up area of the FAT1 area 35 and stores the same information as the FAT1 area 35.

It is preferable that continuous clusters be allocated to pieces of file data that constitute a file, respectively. Therefore, the FAT file system allocates available clusters to the pieces of file data in order of cluster number. The FAT1 and the FAT2 store a sequence relationship between the clusters that store the file data. By tracing the information stored in the FAT1 and the FAT2 (hereinafter, simply referred to as “FAT”), the original file is restored.

The root directory entry area 37 stores the file entry of each file belonging to a root directory. The file entry includes file name or folder name, file size, attribute, file update time and date, a flag indicating the head cluster of the file. Depending on the version of the FAT format (such as, for example, FAT16, FAT32, extended FAT (exFAT)), a root directory entry can be stored at an arbitrary address after the FAT.

If a file belongs to a subdirectory belonging to a root directory, the root directory entry area 37 stores a cluster number assigned to the entry of the subdirectory (subdirectory entry) belonging to the root directory. A subdirectory entry area 38 stores the file entry of a file belonging thereto. As illustrated in FIG. 2, the FAT file system writes a subdirectory entry to an arbitrary cluster (the subdirectory entry area 38) in the file data block 32. The subdirectory entry also belongs to the management data and is frequently rewritten.

FIG. 3 illustrates an example of the FAT and the file entry. As illustrated in FIG. 3, the root directory entry stores, as file entry, the position information of the head cluster of individual files “FILE1. txt”, “FILE2. txt”, and “FILE3. txt”. The head clutters of the files “FILE1. txt”, “FILE2. txt”, and “FILE3. txt” are clusters 0002, 0005, and 0007, respectively.

The FAT stores the number of the next cluster to be assembled next to each cluster. For example, in the case of the file “FILE1. txt”, a cluster that stores data subsequent to data in the head cluster 0002 is a cluster 0003, and a cluster that stores data subsequent to the data in the cluster 0003 is a cluster 0004. By assembling the data in the clusters 0002, 0003, and 0004, the file “FILE1. txt” is restored. Incidentally, “FFFF” is written to a cluster that stores the last portion of file data.

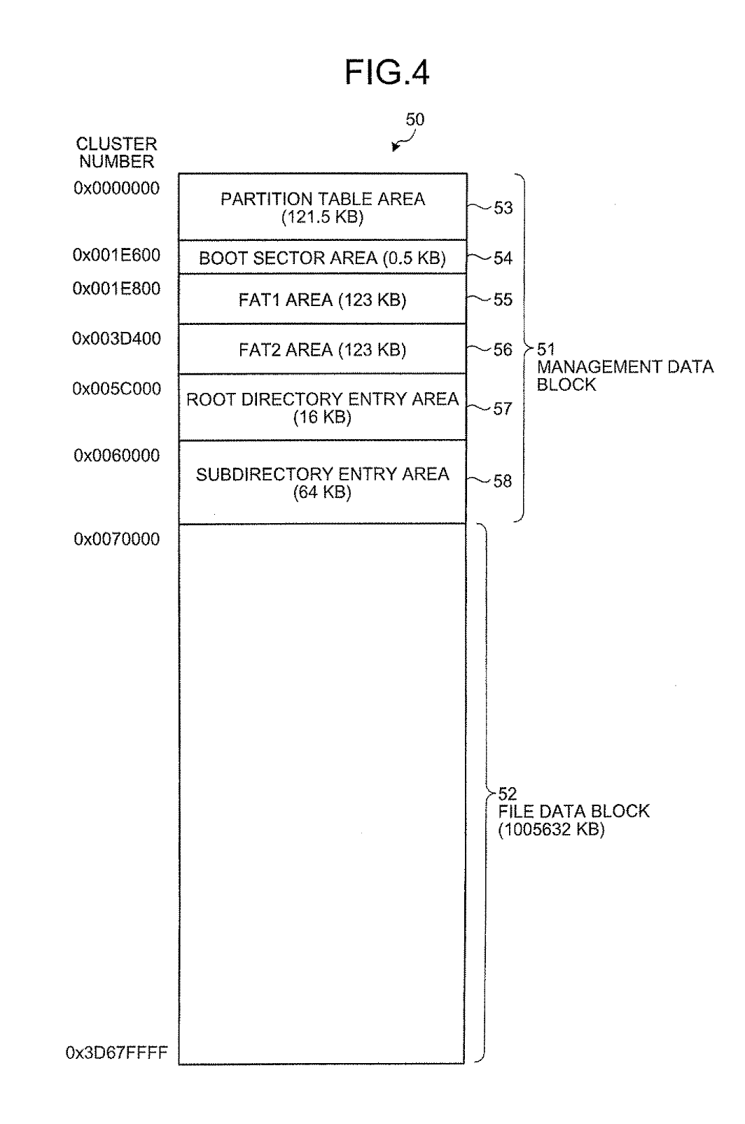

With reference to FIG. 4, a description will be given of the file system 102 of the embodiment based on the FAT file system. The file system 102 of the embodiment logically formats the memory 202 as described below. That is, the memory 202 is logically formatted by the file system 102.

FIG. 4 illustrates an example of a memory space 50 of a memory logically formatted by the file system 102 of the embodiment. The memory space 50 illustrated in FIG. 4 corresponds to the user data area 202c available for the file system 102 in the storage area of the memory 202 to be formatted.

As illustrated in FIG. 4, the file system 102 limits an area, to which is assigned the management data that the file system 102 uses to manage file data, to an area from the bottom to a cluster with a cluster number (or a logical address) within a predetermined range. In other words, an area with a cluster number (or a logical address) within the predetermined range is allocated to the management data. Examples of the management data include a partition table, a boot sector, FAT1 and FAT2, a root directory entry, and a subdirectory entry as those used in the FAT file system.

The management data is stored in a management data block 51. The management data block 51 includes a partition table area 53 allocated to a partition table, a boot sector area 54 allocated to a boot sector, a FAT1 area 55 and a FAT2 area 56 allocated to FAT1 and FAT2, respectively, a root directory entry area 57 allocated to a root directory entry, and a subdirectory entry area 58 allocated to a subdirectory entry. The partition table area 53 to the subdirectory entry area 58 store the same data as defined in the conventional FAT file system.

The memory space 50 includes, in addition to the management data block 51, a file data block 52 dedicated to write file data. The capacity of the management data block 51 is determined taking into account the size of the memory space 50 and the size of the file data block 52 required to be secured. For example, the capacities of the partition table area 53, the boot sector area 54, the FAT1 area 55, the FAT2 area 56, the root directory entry area 57, and the subdirectory entry area 58 are 121.5 KB, 0.5 KB, 123 KB, 123 KB, 16 KB, and 64 KB, respectively. The capacity of the file data block 52 is 1005632 KB.

The file system 102 is on the basis of the FAT file system (regardless of the difference among FAT16, FAT32, exFAT, and the like). Further, apart from the FAT file system, similar file systems including exFAT may be used. As an example of such a file system may be cited the one in which file data is managed based on management data, and the management data is frequently rewritten.

The memory card 200 of the embodiment is logically formatted by the file system 102. Accordingly, the memory 202 is logically formatted as illustrated in FIG. 4.

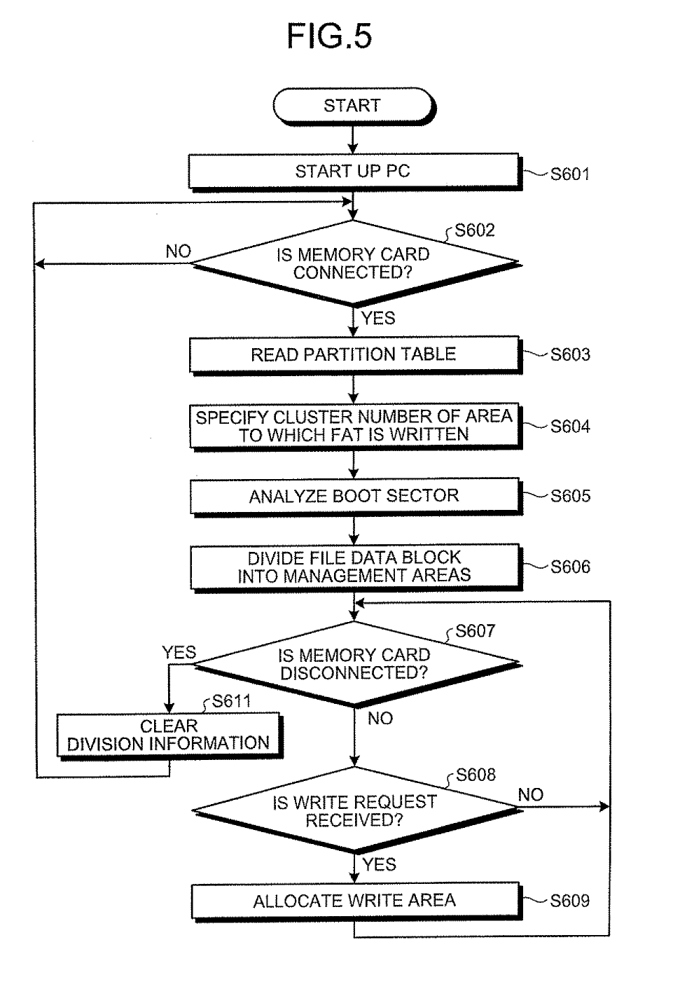

With reference to FIG. 5, a description will be given of the process of allocating a storage area to file data to be written to the memory 202 logically formatted as illustrated in FIG. 4. FIG. 5 is a flowchart of a storage area allocation process performed by the file system 102 according to the embodiment.

First, upon start up of the PC 100 (S601), the file system 102 waits for the memory card 200 to be connected to the memory card I/F 103 (No at S602). When the memory card 200 is connected to the memory card I/F 103 (Yes at S602), the file system 102 accesses the user data area 202c in the memory 202 to read a partition table from the partition table area 53 in the user data area 202c (S603).

The file system 102 then specifies the cluster number (or the logical address) of the FAT1 area 55 and the FAT2 area 56 to which the FAT1 and the FAT2 are written, respectively, among areas in the user data area 202c based on the read partition table (S604) The file system 102 analyzes the boot sector area 54 located in the head sector indicated by the read partition table (S605). More specifically, the file system 102 analyzes the boot sector area 54, thereby reading the 523 indicating various parameters of the memory 202 including, among areas in the user data area 202c, the cluster number and size of the file data block 52, the cluster number and size of the root directory entry area 57 and the subdirectory entry area 58 to which a root directory and a subdirectory are written, respectively, and the like.

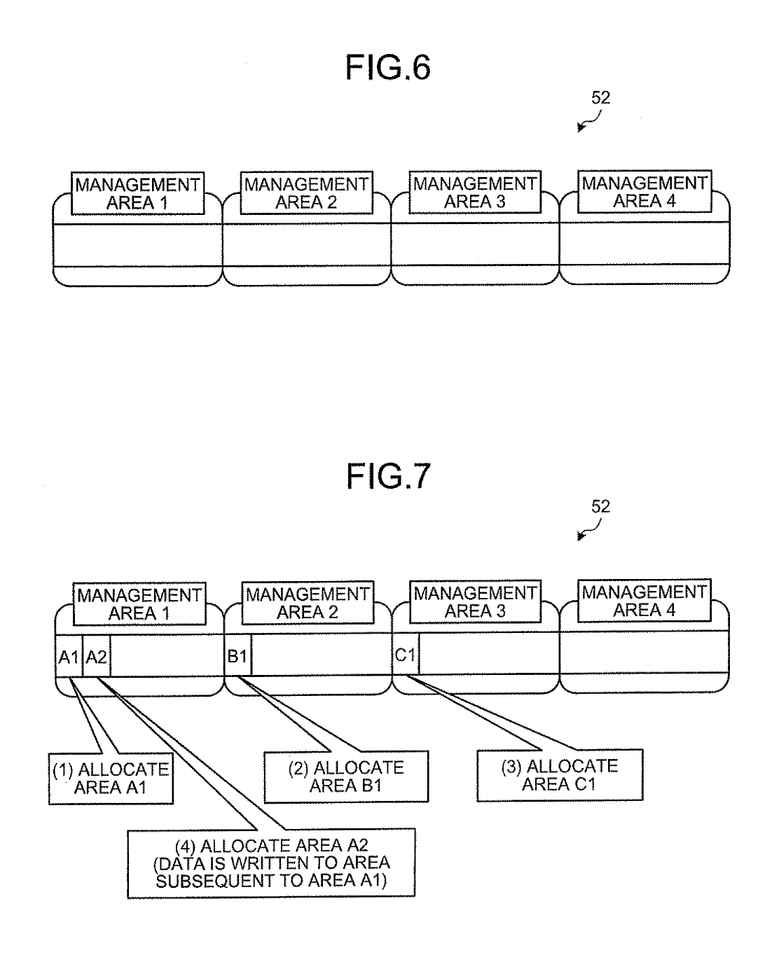

Further, the file system 102 (dividing module) divides the file data block 52 indicated by the cluster number and size read by analyzing the boot sector area 54 into a plurality of management areas, and also stores the cluster number of the lowest (highest) cluster in each of the management areas as division information (S606). FIG. 6 illustrates an example of the file data block 52 divided into a plurality of management areas. It is assumed herein that the file system 102 divides the file data block 52 into management areas of the number of the software 101 (applications) (for example, four) executed by the PC 100. It is also assumed herein that the file system 102 divides the file data block 52 into management areas 1 to 4 of a size dividable by a size that allows faster writing of file data (for example, 512 KB), and secured remaining areas as general areas.

Thereafter, the file system 102 monitors whether the memory card 200 is disconnected from the memory card I/F (S607) as well as waiting for a request to write file data from the software 101 (applications) (S608). If the memory card 200 is disconnected from the memory card I/F 103 (Yes at S607), the file system 102 clears the stored division information (S611), and the process returns S602.

On the other hand, if the memory card 200 is not disconnected from the memory card I/F 103 (No at S607), and the file system 102 receives a write request to write file data from the software 101 (Yes at S608), the file system 102 (allocation module) performs the allocation of a cluster (write area) to which the file data is to be written in response to the write request (S609). The file system 102 outputs the logical address of a logical block including allocated clusters and file data corresponding to write requests to the controller 201.

More specifically, when writing file data to the file data block 52 in response to a write request, the file system 102 accesses the root directory entry area 57 in the management data block 51 based on the cluster number of a root directory entry indicated by the BPB read at S605 to read the root directory entry. Subsequently, referring to a file name contained in the root directory entry, the file system 102 determines whether file data that constitutes the same file as the file data corresponding to the write request has already been written. When determining that file data that constitutes the same file as the file data corresponding to the write request has already been written, the file system 102 specifies a management area where file data that constitutes the same file as the file data corresponding to the write request has been written referring to a flag and division information contained in the read root directory entry. The flag indicates the head cluster of the file, while the division information indicates the cluster number of the lowest (highest) cluster in each of the management areas.

Thereafter, the file system 102 accesses the FAT1 area 55 and the FAT2 area 56 according to the cluster number specified at S604, and reads the FAT1 and the FAT2. Referring to the FAT1 and the FAT2, the file system 102 then allocates an area, which is subsequent to an area where file data has already been written in the specified management area (i.e., a cluster subsequent to a cluster where file data has been written and “FFFF” is written in the FAT1 or the FAT2), to the file data corresponding to the write request as its write area.

On the other hand, when file data that constitutes the same file as the file data corresponding to the write request has not been written, the file system 102 accesses the FAT1 area 55 and the FAT2 area 56 according to the cluster number specified at S604, and reads the FAT1 and the FAT2. The file system 102 then specifies a management area where file data is yet to be written referring to the FAT1 and the FAT2, and the cluster number of the lowest (highest) cluster in each of the management areas indicated by the division information. After that, the file system 102 allocates an area in the specified management area (a cluster subsequent to the lowest cluster) to the file data corresponding to the write request as its write area. If there are a plurality of management areas where file data is yet to be written, the file system 102 sequentially allocates areas in a management area with a high cluster number indicated by the division information as write areas. Further, if there is no management area where file data that constitutes the same file as the file data corresponding to the write request has been written and there is no management area where file data is yet to be written, the file system 102 allocates an area subsequent to an area where file data has already been written in any one of the management areas (i.e., a cluster subsequent to a cluster where file data has been written and “FFFF” is written in the FAT1 or the FAT2) as the write area. The one of the management areas may be, for example, a management area with a high cluster number indicated by the division information.

FIG. 7 is a schematic diagram for explaining the allocation of write areas. It is assumed, for example, that a write request is received that requests to write file data constituting a file A when file data is yet to be written to the management areas 1 to 4. In such a case, the file system 102 allocates an area A1, which is formed of a cluster subsequent to the head cluster in the management area 1 with the lowest cluster number indicated by the division information, to the file data corresponding to the write request as its write area (indicated by (1) in FIG. 7). Further, it is assumed, for example, that a write request is received that requests to write file data constituting a file B when file data is written only to the management area 1. In such a case, the file system 102 allocates an area B1, which is formed of a cluster subsequent to the head cluster in the management area 2 with the lowest cluster number next to the cluster number of the management area 1 indicated by the division information, to the file data corresponding to the write request as its write area (indicated by (2) in FIG. 7). Still further, it is assumed, for example, that a write request is received that requests to write file data constituting a file C when file data is written to the management areas 1 and 2. In such a case, the file system 102 allocates an area C1, which is formed of a cluster subsequent to the head cluster in the management area 3 with the lowest cluster number next to the cluster number of the management area 2 indicated by the division information, to the file data corresponding to the write request as its write area (indicated by (3) in FIG. 7). Still further, it is assumed, for example, that a write request is received that requests to write file data constituting the file A subsequent to the file data written to the area A1 when file data is written to the management areas 1 to 3. In such a case, the file system 102 allocates an area A2 subsequent to the area A1 in the management area 1 to the file data corresponding to the write request as its write area (indicated by (4) in FIG. 7).

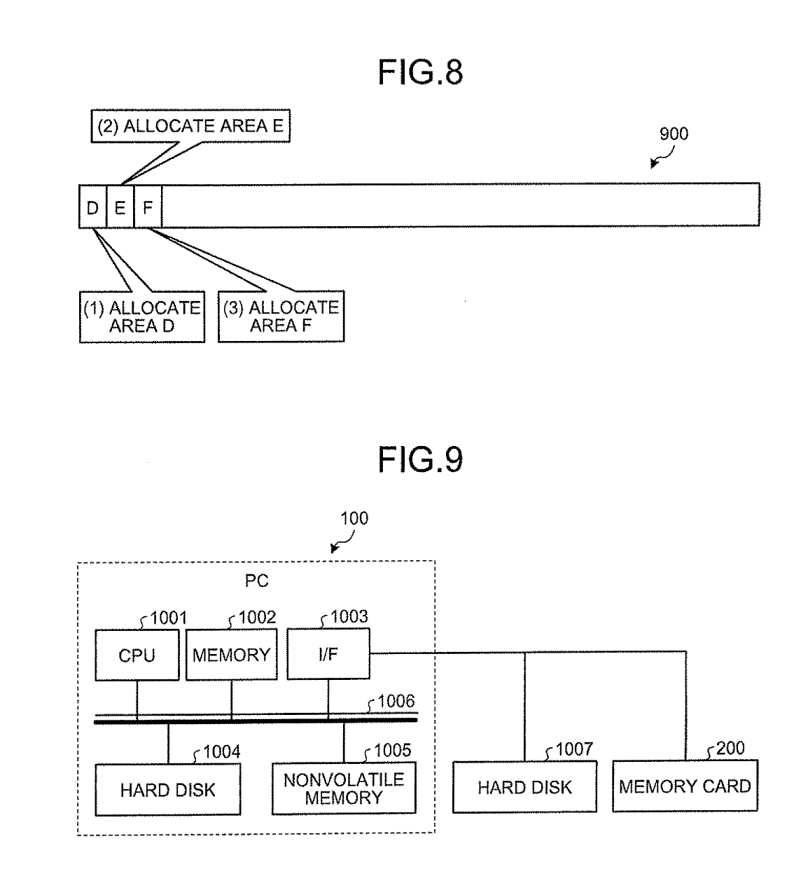

FIG. 8 is a schematic diagram for explaining the allocation of write areas according to a conventional technology. It is assumed, for example, that a write request is received that requests to write file data constituting a file d when file data is yet to be written to a management area 900. In such a case, a conventional file system allocates an area D, which is formed of a cluster subsequent to the head cluster in the management area 900, to the file data corresponding to the write request as its write area (indicated by (1) in FIG. 8). Further, it is assumed, for example, that a write request is received that requests to write file data constituting a file e when the file data constituting the file d is written to the area D of the management area 900. In such a case, the conventional file system allocates an area E subsequent to the area D to the file data corresponding to the write request as its write area (indicated by (2) in FIG. 8). Still further, it is assumed, for example, that a write request is received that requests to write file data constituting a file f when the file data constituting the files d and e are written to the areas D and E of the management area 900. In such a case, the conventional file system allocates an area F subsequent to the area E to the file data corresponding to the write request as its write area (indicated by (3) in FIG. 8).

As described above, the conventional file system sequentially writes file data constituting different files at random to the management area 900. This results in the loss of the continuity of file data constituting the same file and thereby lower processing speed to write the file data to or read the file data from the memory area. On the other hand, the file system of the embodiment prevents file data constituting different files from being written to the same management area as much as possible. Thus, file data that constitute each file are more likely to be written continuously.

It is assumed herein that, upon receipt of a logical address and file data output from the file system 102, the MPU 201b of the controller 201 converts the logical address to a physical address using the logical-to-physical table stored in the RAM 201d, and also writes the received file data to a page indicated by the physical address.

FIG. 9 is a block diagram of the PC 100 of the embodiment. The PC 100 comprises a central processing unit (CPU) 1001 that controls the overall operation of the PC 100. A nonvolatile memory 1005 and a memory 1002 are connected to the CPU 1001 via a bus 1006. The nonvolatile memory 1005 may be, for example, a read only memory (ROM), and stores a basic input-output system (BIOS) and the like. The memory 1002 may be, for example, a random access memory (RAM) that is rewritable and stores various types of data. Further, a hard disk 1004 and an interface (I/F) 1003 are connected to the bus 1006 via an I/O (not illustrated). The hard disk 1004 stores various programs including a program for storage area allocation, and the like. The I/F 1003 is provided with a universal serial bus (USB) connector for connecting an external hard disk 1007 to the PC 100, the memory card I/F 103 to which is connected the memory card 200 such as SD card, and the like.

Since the memory 1002 is rewritable, it functions as a work area of the CPU 1001 and serves as a buffer.

The nonvolatile memory 1005 is a storage medium that stores an operating system (OS) and various types of programs. The CPU 1001 reads the programs from the nonvolatile memory 1005 and installs them on the hard disk 1004.

Examples of the storage medium include, in addition to the nonvolatile memory 1005, various types of optical disks such as a digital versatile disk (DVD), various types of magneto-optical disks, various types of magnetic disks such as a flexible disk (FD), semiconductor memories, and the like. The programs may be downloaded through a network such as the Internet via a communication controller (not illustrated) and installed on the hard disk 1004. In this case, a storage device of a server that stores the programs at the sending end is also an example of the storage medium. The programs may run on a predetermined OS, and, in this case, part of various types of processing of the programs may be performed by the OS. The programs may be part of a group of program files that constitute predetermined application software and the OS.

The CPU 1001 that controls the overall operation of the system performs various types of processing according to a program loaded into the hard disk 1004 used as a main storage device of the system.

The program executed on the PC 100 comprises modules including the software 101, the file system 102, and the memory card I/F 103. As actual hardware, the CPU 1001 (processor) loads the program from a storage medium into the main storage device and executes it, thereby implementing the software 101, the file system 102, and the memory card I/F 103.

As described above, according to an embodiment of the invention, the file data block 52 is divided into a plurality of management areas. Upon receipt of a request to write file data, the PC 100 specifies a management area where file data that constitutes the same file as the file data corresponding to the write request has been written. The PC 100 allocates an area in the management area, which is subsequent to an area where the file data has been written, to the file data corresponding to the write request as its write area. In this manner, the PC 100 prevents file data constituting different files from being written to the same management area as much as possible. Thus, even if there is some interval between write operations of file data constituting the same file, the file data are more likely to be written continuously.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic device comprising:
a dividing module configured to divide a data storage area, to which file data constituting a file is to be written, into a plurality of management areas, the data storage area being in a storage area of a storage medium; and
an allocation module configured to allocate, upon receipt of a write request to write file data, an area to the file data corresponding to the write request as a write area, the write area being subsequent to an area where file data is written in a management area where file data constituting a same file as the file data corresponding to the write request is written.

2. The electronic device of claim 1, wherein, when file data constituting the same file as the file data corresponding to the write request has not been written, the allocation module allocates an area in a management area where file data is not written as the write area.

3. The electronic device of claim 2, wherein when file data constituting the same file as the file data corresponding to the write request has not been written and there is no management area where file data is not written, the allocation module allocates an area subsequent to an area where file data is written in one of the management areas as the write area.

4. The electronic device of claim 1, wherein the dividing module is configured to divide the data storage area into the management areas according to number of applications that request to write file data.

5. A storage area allocation method for a file system comprising:
a dividing module dividing a data storage area, to which file data constituting a file is to be written, into a plurality of management areas, the data storage area being in a storage area of a storage medium; and
an allocation module allocating, upon receipt of a write request to write file data, an area to the file data corresponding to the write request as a write area, the write area being subsequent to an area where file data is written in a management area where file data constituting a same file as the file data corresponding to the write request is written.

6. A computer program product embodied on a computer-readable medium and comprising code that, when executed, causing a computer to implement:
a dividing module dividing a data storage area, to which file data constituting a file is to be written, into a plurality of management areas, the data storage area being in a storage area of a storage medium; and
an allocation module allocating, upon receipt of a write request to write file data, an area to the file data corresponding to the write request as a write area, the write area being subsequent to an area where file data is written in a management area where file data constituting a same file as the file data corresponding to the write request is written.
